(19) United States
(12) Patent Application Publication
(10) Pub. No.: US 2014/0182422 A1
(43) Pub. Date: Jul. 3, 2014

(54) Spark Plug Installation Tool

(71) Applicant: LISLE CORPORATION, Clarinda, IA (US)

(72) Inventor: Scotty R. Kurtz, Clarinda, IA (US)

(73) Assignee: Lisle Corporation, Clarinda, IA (US)

(21) Appl. No.: 13/729,798

(22) Filed: Dec. 28, 2012

(51) Int. Cl. B25B 13/48

(52) U.S. Cl. CPC B25B 13/483
USPC 81/177.1

(57) ABSTRACT

A spark plug installation tool includes to a grip handle, a coaxial, flexible shaft extending from the handle and a co-axial socket receiver assembly for engaging a spark plug socket. The distal end of the socket receiver assembly includes a magnet. The socket receiver assembly further includes a peripheral rim to limit the insertion of the socket receiver assembly into a socket drive opening.

### BACKGROUND OF THE INVENTION

In a principal aspect the present invention relates to a tool for installation of spark plugs into an engine block.

From time to time internal combustion engines of the type which use spark plugs to initiate fuel ignition must be serviced by replacement of the spark plugs. Typically, a special sized and configured spark plug socket is utilized to engage the polygonal rim of the spark plug so it may be rotated and thereby removed from an engine block or head. Alternatively, the spark plug socket may also be used to insert the spark plug into the engine block or head and to tighten the plug in position.

Nonetheless, it is difficult to insert a spark plug into an engine block or head. As a consequence, mechanics and vehicle repair service providers have developed various special spark plug socket tools which facilitate replacement of spark plugs. For example, a tool of this general nature is depicted in U.S. Pat. No. 5,074,173 for a “Spark Plug Tool” issued Dec. 24, 1991, incorporated herewith by reference. The tool includes a flexible shaft which is secured to a specially constructed tubular spark plug socket at one end and to a handle located on the other end of the flexible shaft. The tubular housing or socket includes internal polygonal sides that mate with the polygonal sides of a spark plug. A resilient liner is located within the housing to protect the porcelain insulation sheath of the plug when engaged or disengaged from the socket or housing.

While such a tool is useful, the problem of appropriately engaging and aligning a spark plug within the socket and retaining the plug within the socket is often encountered. That is, the plug may not remain properly lodged within the socket. Further, the liner may become dirty and contaminate the plug. This is a problem which may also result with other types of spark plug sockets.

Thus, there has developed the need for an improved spark plug installation tool which has broad or universal application, yet which provides the capability of protecting the spark plug during installation. A further desired aspect is availability of a tool which is useful with various types and shapes of spark plug sockets as well as general purpose sockets, not limited to application for use only with spark plugs.

### SUMMARY OF THE INVENTION

Briefly, the present invention comprises a spark plug installation tool which includes a grip handle, an elongate shaft extending axially from the handle, and a socket receiver assembly or socket driver attached to the end of the shaft opposite the handle. The socket driver is configured to engage and retain a spark plug socket or a standard long socket. In an embodiment of the invention, the elongate shaft is flexible to facilitate positioning of the socket driver and an attached socket in places that are not easily accessed. Further, the socket receiver assembly or driver affixed to the distal end of the elongate shaft includes a polygonal (typically square) shape to enable engagement with a standard long drive socket opening and also includes a peripheral rib to limit the degree of insertion of the socket receiver assembly into the drive end of a socket such as a spark plug socket or standard long socket. The socket receiver assembly includes a magnet at its outer end to retain a spark plug within a socket which is mounted on the receiver assembly or driver. The tool may be used in combination with standard sockets or spark plug sockets. In at least one embodiment, a socket with which the tool is used, includes a throughpassage so that the magnet or magnetized outer end of the socket receiver assembly may engage the tip or metallic end of a spark plug and hold the plug within the socket to thereby insure that the spark plug will be maintained in proper alignment position during installation,

Thus, it is an object of the invention to provide an improved spark plug socket installation tool.

A further object of the invention is to provide a spark plug installation tool which is useful for achieving proper alignment of a spark plug in an engine block or head plug opening and thereby avoid cross threading of the plug by aligning the plug in a plug opening.

Another object of the invention is to provide a spark plug installation tool which is rugged, inexpensive and useful with multiple types of sockets.

These and other objects, advantages and feature of the invention will be set forth in the detailed description which follows.

### BRIEF DESCRIPTION OF THE DRAWING

In the detailed description which follows, reference will be made to the drawing comprised of the following figures:

FIG. 1 is a side elevation view of an embodiment of the invention depicting a handle with an elongate, flexible shaft extending therefrom and a socket engaging or receiving assembly affixed to the end of the elongate, flexible shaft;

FIG. 2 is a cross sectional of the socket receiver assembly attached to the shaft viewed along the sectional line 2-2 in FIG. 1;

FIG. 3 is a cross sectional view of the socket receiver assembly taken along the line 3-3 in FIG. 1; and

FIG. 4 is an exploded, isometric view in partial section of the combination of the socket driver assembly engaged with a socket.

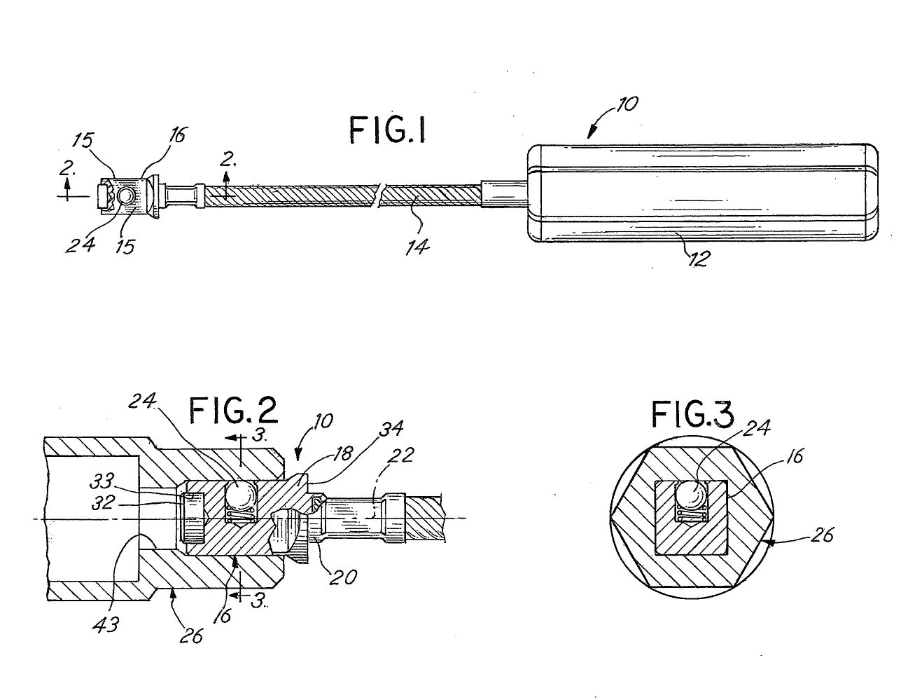

### DETAILED DESCRIPTION OF EMBODIMENTS OF THE INVENTION

Referring to the figures, the installation tool 10 of the invention includes a manual grip handle 12 with an axially extending flexible shaft or cable 14 joined to a socket receiver assembly or socket driver 16. The socket receiver assembly 16 has a polygonal cross section as depicted in FIG. 3. The socket receiver assembly 16 further includes a peripheral outer rim assembly 18 at the end 34 adjacent the outer end 20 of the shaft 14. The receiver assembly 16 is thus integral with, attached or affixed to the distal end 20 of the shaft 14 and is coaxial with the axis 22 of the shaft 14 and handle 12. The axis 22 is generally an axis of symmetry for the tool.

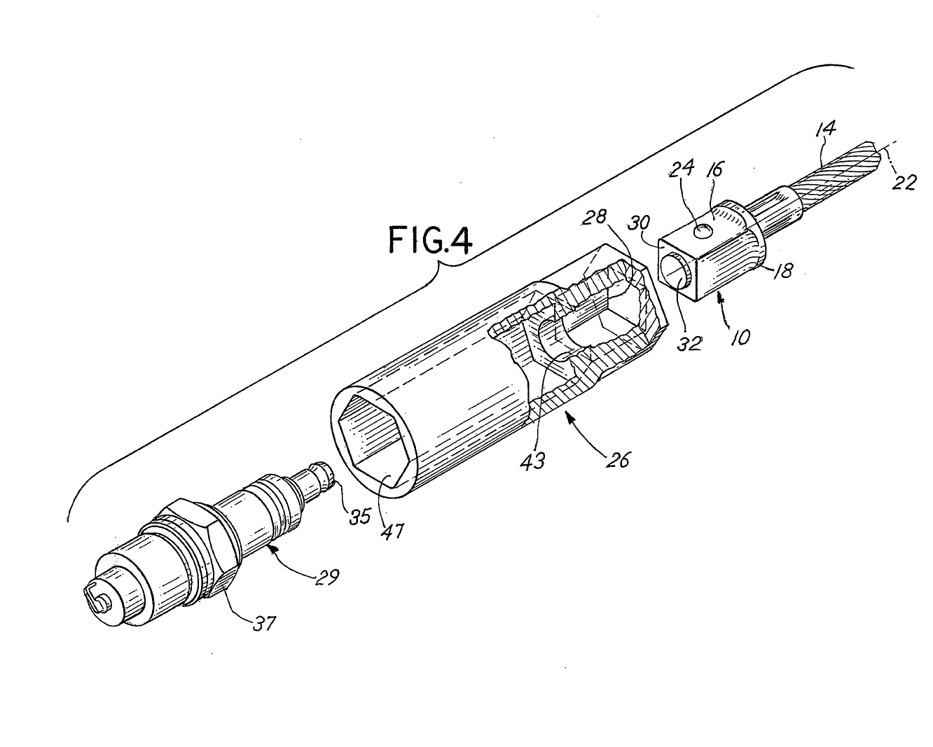

The socket receiver assembly 16 further includes a radially directed, spring biased detent engaging ball 24 which serves to retain engagement between the assembly 16 and a socket, such as socket 26. The socket 26 includes a keyed (typically square polygonal) center or axial passage 28 which receives the compatible cross sectional shape of body 15 of the socket receiver assembly 16 to be retained by the detent ball 24. The extreme distal end 30, shown in FIG. 4, of the socket receiver assembly 16 includes an embedded magnet 32 which is retained by epoxy, by way of example, in an axial end, counterbore 33. The receiver assembly 16 includes a peripheral rim 18 which limits insertion of receiver assembly 16 into passage 28 of socket 26.

The socket receiver assembly 16 thus is fitted into the compatible passage 28 of socket 26, for example, a standard long spark plug socket. Typically, the passage 28 extends axially partially through the socket 26 and may connect to an axial passage 43 to a polygonal passage 47. A metal element such as the contact tip 35 of a spark plug 29 can then be engaged or otherwise retained in coaxial alignment and magnetically by the magnet 32 which projects into passage 43 from the passage 28. The socket 26 may thus be a standard spark plug socket 26. Alternatively, socket 26 may be lined with a resilient material to protect the insulating or porcelain material of a plug 29. However, the magnet 32 is generally an adequate means to maintain the spark plug 29 in aligned position within the socket 26.

The standard long socket 26 typically has polygonal, internal cross section 47 which mates with the polygonal rim or flange 37 of a spark plug 29. Thus, an advantage of the described construction is that a resilient material or some other type of socket lining material is generally not needed in order to protect the insulated portion of a plug 29. This results since the magnet 32 holds a plug 29 in a fixed co-axial position. That is, the plug 29 is held generally co-axially within the spark plug socket 26.

The socket 26 typically includes the reduced diameter section 43 between internal polygonal passage 47 and the passage 28. The reduced diameter portion 43 and magnet 32 may thus, in combination further act to hold a plug 29 in position fixed in socket 26 due to the magnetic attraction of magnet 32 located at or near the outer end or contact 35 of a plug 29.

The drawing depicts a standard long spark plug socket 26. However, other sizes and types of sockets may be coupled with the tool. Thus, standard long sockets may be utilized and bolts or other types of fasteners may be positioned within a standard socket and held in aligned position precisely by means of the magnet 32 which will magnetize and engage and bold sockets, fasteners or other items in position in combination with the socket receiver assembly 16 maintained at the end of the shaft 14.

The socket receiver section 16, flexible shaft 14 and grip 12 also serve a dual purpose. That is, the magnet 32 at the end of the section 16 can be utilized to magnetically pick up items which may have dropped, such as bolts, nails, screws or the like. A duality of functionality is thereby attributed to the combination of the handle 12, shaft 14 and socket receiver section 16.

Variations of the tool are possible. For example, the shapes of the component parts may be altered. The shaft 14 may be variably flexible. The socket retainer ball 24 may be replaced by magnetic material. The rim 18 may be continuous or segmented or a radial projection.

Thus while there has been set forth an embodiment of the invention, the invention is limited only by the following claims and equivalents thereof.

What is claimed is:

1. A magnetic socket driver for a spark plug installation tool, said driver including:
(i) a grip handle,
(ii) an elongate shaft extending axially from the handle and terminating at a distal end;
(iii) a socket receiver assembly affixed to the distal end of said shaft opposite to said handle, said receiver assembly including a socket engagement body having a shaft connection end connected to said distal end of said shaft and an outer end, said body including a keyed cross-section portion configured to cooperatively engage a drive socket opening of a socket and to retain said socket, said body further including a peripheral rib element to limit insertion of said body into a said drive socket opening and a magnet at the outer end of the body to magnetically retain a spark plug positioned axially within a said drive socket opening and with said plug coaxially aligned with said body.

2. The tool as set forth in claim 1 wherein the socket receiver assembly body has a generally square cross-section transverse to the axis of said body.

3. The tool of claim 1 including a socket attached to the socket receiver assembly.

4. The tool of claim I wherein said shaft is flexible.

5. A spark plug installation tool comprising:
a magnetic socket driver, said driver including:
(i) a grip handle,
(ii) an elongate shaft extending axially from the handle and terminating at a distal end;
(iii) a socket receiver assembly affixed to the distal end of said shaft opposite to said handle, said receiver assembly including a socket engagement body having a shaft connection end connected to said distal end of said shaft and an outer end, said body including a polygonal cross-section portion configured to cooperatively engage a drive socket opening of a socket to retain said socket, said body further including a peripheral rib element to limit insertion of said body into a said drive socket opening and a magnet at the outer end of the body to magnetically retain a spark plug positioned axially within a said drive socket opening with said body and a said plug coaxially aligned;
(iv) a socket attached to the socket receiver assembly; and
(v) wherein said shaft is flexible.

6. A spark plug installation tool comprising:
a magnetic socket driver, said driver including:
(i) a grip handle,
(ii) an elongate shaft extending axially from the handle and terminating at a distal end;
(iii) a socket receiver assembly affixed to the distal end of said shaft opposite to said handle, said receiver assembly including a socket engagement body having a shaft connection end connected to said distal end of said shaft and an outer end, said body including a polygonal cross-section portion configured to cooperatively engage a drive socket opening of a socket to retain said socket, said body further including a peripheral rib element to limit insertion of said body into a said drive socket opening and a magnet at the outer end of the body to magnetically retain a spark plug positioned axially within a said drive socket opening with said body and a said plug coaxially aligned;
(iv) including a spark plug socket attached to the socket receiver assembly;
(v) wherein said shaft is flexible; and
(vi) wherein the socket receiver assembly body had a generally square cross-section transverse to the axis of said body.

7. The tool of claim 3 wherein said spark plug socket includes a resilient liner.

8. The tool of claim 3 wherein the socket includes an axial through passage for receipt of a said spark plug.

9. The tool of claim 8 wherein said socket is a spark plug socket including a shaped section compatible with a plug and a reduced cross sectional section to limit the insertion of a spark plug into said through passage.

10. The tool of claim 1 including a ball detent retainer in said body for retaining a socket and wherein said rib is adjacent the distal end of said shaft and further including an axial counterbore in said outer end of said body with a magnet mounted in said counterbore.
